(19) United States
(12) Patent Application Publication
(10) Pub. No.: US 2024/0296831 A1
(43) Pub. Date: Sep. 5, 2024

(54) METHOD AND APPARATUS FOR GENERATING DATA TO TRAIN MODELS FOR PREDICTING INTENT FROM CONVERSATIONS

(71) Applicant: Uniphore Technologies, Inc., Palo Alto, CA (US)

(72) Inventor: Gideon Hollander, Herzliya (IL)

(21) Appl. No.: 18/116,301

(22) Filed: Mar. 2, 2023

(51) Int. Cl. G10L 15/06; G10L 15/18; G10L 15/22; H04M 3/42; H04M 3/523

(52) U.S. Cl. CPC G10L 15/063; G10L 15/1815; G10L 15/22; H04M 3/42221; H04M 3/5232

(57) ABSTRACT

In a method and apparatus for generating training data to train models for predicting intent from conversations, the method includes identifying, from a cluster of calls having a single intent, at least two calls, each having a sequence comprising a first action followed by a second action. The method identifies at least one first portion of the first transcribed text overlapping with the sequence in a first call, and at least one second portion of the second transcribed text overlapping with the sequence, and combining the at least one first portion, the at least one second portion and the intent to generate an automatically generated training data (AGTD) for the intent.

### FIELD

The present invention relates generally to customer service computing and management systems, such as those used in call centers, and particularly to generating data to train artificial intelligence and/or machine learning (AI/ML) models for predicting intent from conversations.

### BACKGROUND

Several businesses need to provide support to its customers, which is provided by a customer service center (also known as a “call center”) operated by or on behalf of the businesses. Customers of a business place an audio or a multimedia call to, or initiate a chat with, the call center of the business, where customer service agents address and resolve customer issues, to address the customer's queries, requests, issues and the like. The agent uses a computerized management system used for managing and processing interactions or conversations (e.g., calls, chats and the like) between the agent and the customer. The agent is expected to understand the customer's issues, provide appropriate resolution, and achieve customer satisfaction.

Customer service management systems (or call center management systems) may help with an agent's workload, complement or supplement an agent's functions, manage agent's performance, or manage customer satisfaction, and in general, such call management systems can benefit from understanding the content of a conversation, such as entities mentioned, intent of the customer, among other information. Such systems may rely on automated identification of intent and/or entities of the customer (e.g., in a call or a chat). Accuracy, efficiency and training time of models depend greatly on the accuracy of the training data, and generating accurate data sets for training models for predicting intent remains a challenge. Most models are currently trained on large volumes of training data because accurate data is not available, and training models with high volumes of training data is expensive, time consuming, and may still result in models lacking desired accuracy. Further, training models with such data typically requires input from data scientists, which is also expensive and potentially cumbersome.

Accordingly, there is a need in the art for method and apparatus for generating data to train models for predicting intent from conversations.

### SUMMARY

The present invention provides a method and an apparatus for generating data to train artificial intelligence and/or machine learning (AI/ML) models for predicting intent from conversations, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an apparatus for generating data to train models for predicting intent from conversations, in accordance with an embodiment of the present invention.

FIG. 2 illustrates a first screen of a graphical user interface (GUI) of an agent device of the apparatus of FIG. 1, in accordance with an embodiment of the present invention.

FIG. 3 illustrates a second screen from the GUI of FIG. 2, in accordance with an embodiment of the present invention.

FIG. 4 illustrates a screen of a GUI of a business analyst device of the apparatus of FIG. 1, in accordance with an embodiment of the present invention.

FIG. 5 illustrates a method for generating data to train models for predicting intent from conversations, in accordance with an embodiment of the present invention.

### DETAILED DESCRIPTION

Embodiments of the present invention relate to generating data to train artificial intelligence and/or machine learning (AI/ML) models for predicting intent from conversations, for example, conversations between a customer and an agent of a customer service center, or between two or more persons in other environments. Embodiments disclosed herein generate training data sets by clustering several conversations or calls, or transcribed text thereof, according to call intent. The intent used for clustering the calls is assigned by the agent working on the call in the call summary, or obtained by other means, for example, from a model trained to correlate agent's screen activity with call intent.

For a given intent cluster, the screen activity of agents working on a graphical user interface (GUI) screen during calls with customers, known as agent activity data, is also recorded. The time intervals with similar or matching agent activity data in different calls within an intent cluster are identified. The conversation portion during, and optionally before and/or after such time intervals in each such call is identified as relevant to the call intent. The identified relevant conversations portion or transcribed text thereof is referred to as automatically generated training data, and is usable to train models for determining intent from conversations. In some embodiments, the automatically generated training data is further validated by a person knowledgeable about the business, for example, by a business analyst, to further increase the relevancy/accuracy of the automatically generated training data, and to generate validated training data for training models for predicting intent from conversations.

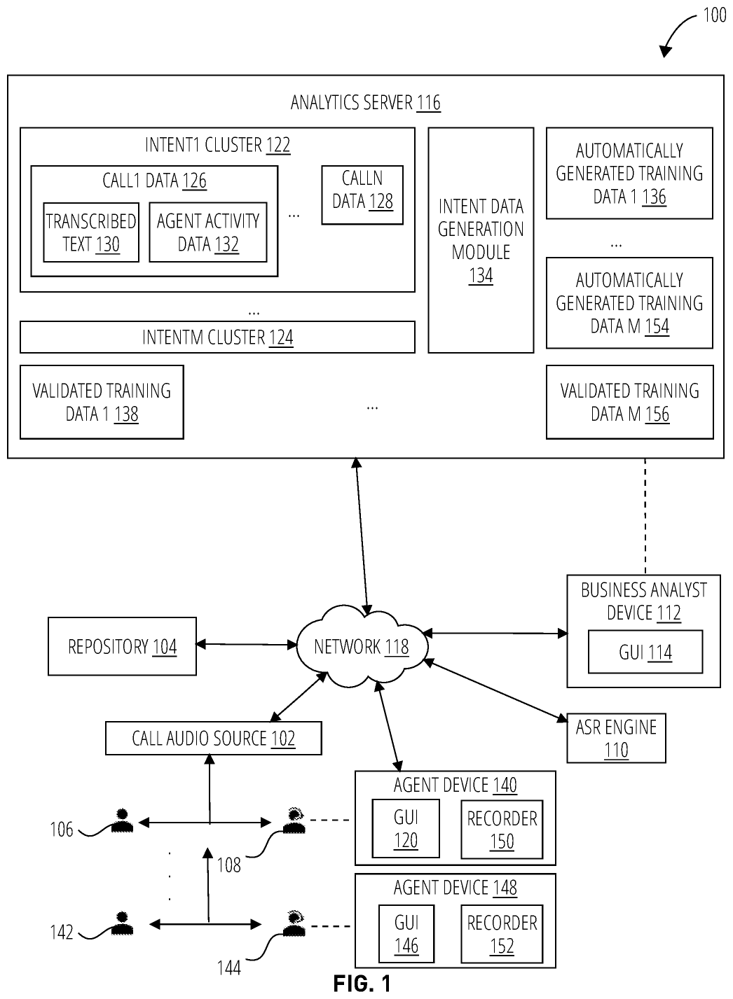

FIG. 1 illustrates an apparatus 100 for generating data to train models for predicting intent from conversations, in accordance with an embodiment of the present invention. The apparatus 100 includes a call audio source 102, for example a customer service center or call center, to which customers 106, 142 of a business call in for support or service, and agents 108, 144 working on behalf of the business, address the calls of the customers 106, 142, respectively. The apparatus 100 includes agent devices 140, 148 accessible to the agents 108, 144, respectively. The apparatus 100 further includes a repository 104, an automatic speech recognition (ASR) Engine 110, a business analyst device 112, an analytics server 116, and a network 118 communicably coupling components of the apparatus 100.

The call audio source 102 provides audio of a conversation, for example, a call between the customer 106 and the agent 108, or between the customer 142 and the agent 144, to the ASR Engine 110. In some embodiments, the audio is streamed to the ASR Engine 110 while a call is active, and in some embodiments, the audio is sent to the ASR Engine 110 after the call is concluded. The ASR Engine 110 transcribes the audio to text data, which is then sent to, and stored in, the repository 104. In some embodiments, the call audio source 102 sends the audio to the repository 104 for storage, and the stored audio may be transcribed at a later time, for example, by sending the audio from the repository 104 to the ASR Engine 110. The transcribed text may be sent from the ASR Engine 110 directly to the analytics server 116, or to the repository 104 for later retrieval by the analytics server 116.

In some embodiments, the agent 108 interacts with a graphical user interface (GUI) 120 of an agent device 140 for providing inputs and viewing outputs, before, during and after a call. The agent device 140 is a general computer, such as a personal computer, a laptop, a tablet, a smartphone, as known in the art, and includes the GUI 120, among other standard components, such as a camera, a microphone, among others as known in the art. In some embodiments, the GUI 120 is capable of displaying, to the agent 108, various workflows and forms configured to receive input information about the call, and receiving, from the agent 108, one or more inputs, for example, to change address of the customer 106, make a travel booking, among various other functions. Similar to the agent 108 interacting with the GUI 120 of the agent device 140, the agent 144 interacts with the GUI 146 of the agent device 148, which has similar capability and functionality as the agent device 140. The agent devices 140, 148 include recorders 150, 152, respectively, to record the activity of the agents 108, 144 on the respective GUIs 120, 146 during the call, respectively, as agent activity data, and send the agent activity data to the repository 104 for storage therein, and retrieval, for example, by the analytics server 116. In some embodiments, the agent activity data is sent directly from the agent devices 140, 148 to the analytics server 116. In this manner, transcribed text and agent activity data of several conversations is aggregated and made available for access to the analytics server 116. In some embodiments, the recorders 150, 152 include an eye tracking functionality to determine which areas of a display screen (GUI) the agent is looking at while the agent is performing an operation on the GUI. In some embodiments, the recorders 150, 152 include functionality to monitor GUI interactions of agent occurring on the agent device, such as the data entered into a field on a screen or GUI and the corresponding field label, cursor position, clicking information. The data points from eye tracking and from agent interactions with the GUI, clicking, highlighting, typing, hovering and the like are recorded as the agent activity data.

In some embodiments, the repository 104 stores recorded audios of conversations or calls between a customer and an agent, for example, the customer 106 and the agent 108, or the customer 142 and the agent 144, received from the call audio source 102. In some embodiments, the repository 104 stores transcribed text of the conversations, for example, received from the ASR Engine 110. In some embodiments, the repository 104 stores audios of some conversations, and transcribed text of some conversations, or both the audios and transcribed text of some conversations. The repository 104 also stores the agent activity data, such as activity of the agent 108 with respect to a graphical user interface (GUI) 120 of the agent device 140, for example, typing in, clicking on, hovering a cursor on or near, or eye movement to or eye focus (such as for reading) at a field on the GUI. Similarly, the repository 104 stores the conversation audio and/or transcribed text between the customer 142 and the agent 144, and the screen activity performed by the agent 144 on a GUI 146 of the agent device 148.

The ASR Engine 110 is any of the several commercially available or otherwise well-known ASR Engines, providing ASR as a service from a cloud-based server, a proprietary ASR Engine, or an ASR Engine which can be developed using known techniques. ASR Engines are capable of transcribing speech data (spoken words) to corresponding text data (transcribed text, text words or tokens) using automatic speech recognition (ASR) techniques, as generally known in the art, and include a timestamp for some or each token(s).

The business analyst device 112 is a general purpose computer, such as a personal computer, a laptop, a tablet, a smartphone, as known in the art, and includes a GUI 114. The GUI 114 of the business analyst device 112 is used by a person knowledgeable about the business, such as a business analyst, for example, to review and validate training data generated by the analytics server 116. In some embodiments, the business analyst device 112 is configured to communicate directly with analytics server 116, for example, as shown with the broken line.

The analytics server 116 includes various clusters of call data, for example, intent1 cluster 122 . . . intentM cluster 124, an intent data generation module (IDGM) 134, automatically generated training data (AGTD) 136, and a validated training data (VTD) 138.

In some embodiments, the analytics server 116 is provided call data from several calls, which is organized in to clusters according to intent of the calls. Each cluster, for example, intent1 cluster 122, . . . intentM cluster 124 includes call data from several calls identified as having a common call intent. Intent for calls is obtained, for example, from a call summary prepared by agents handling calls, or may obtained from a software that determines an intent of the call based on agent's screen activity. For example, intent1 cluster 122 includes call data for calls 1-N identified by respective agents as having the intent of “change address.” The intent1 cluster 122 includes call1 data 126 . . . callN data 128 for each of the 1-N calls. Similarly, different clusters (for example, intentM cluster 124) may include call data corresponding to multiple calls having an intent different than the intent of intent1 cluster 122.

Each call data includes transcribed text for a call and agent activity data of the agent on the respective GUI for the call. For example, call1 data 126 includes a transcribed text 130 of the call between the customer 106 and the agent 108, and an agent activity data 132 of the agent 108 on the GUI 120. Similarly, callN data 128 includes a transcribed text of the call between a customer 142 and an agent 144, and an agent activity data of the agent 144 on the GUI 146. While two pairs of customers and agents, that is the customer 106 and the agent 108, and the customer 142 and the agent 144, are shown in FIG. 1, it is understood that different calls of a cluster may occur between several different customer(s) and/or agent(s).

Each of the transcribed text and the agent activity data includes chronological indicators, for example, timestamps, to indicate when a word in the transcribed text was spoken, and when an action was taken by the agent. In some embodiments, the transcribed text includes the words spoken in the call arranged in a sequential manner, and the timestamps to determine when one or more words were spoken. The agent activity data includes two or more actions performed by an agent arranged in a sequential manner, although the two or more actions may or may not be consecutive. The actions include any of the input operations that can be performed by agents on the agent device, for example, typing, clicking, highlighting, reading text in a field or a field label, selection of a particular data element or field in a GUI, hovering of a cursor at, or proximate to, a data element for given time (for example, 100 ms), and the like. In some embodiments, the agent activity data also includes the call summary prepared by the agent, and/or the call intent assigned by the agent.

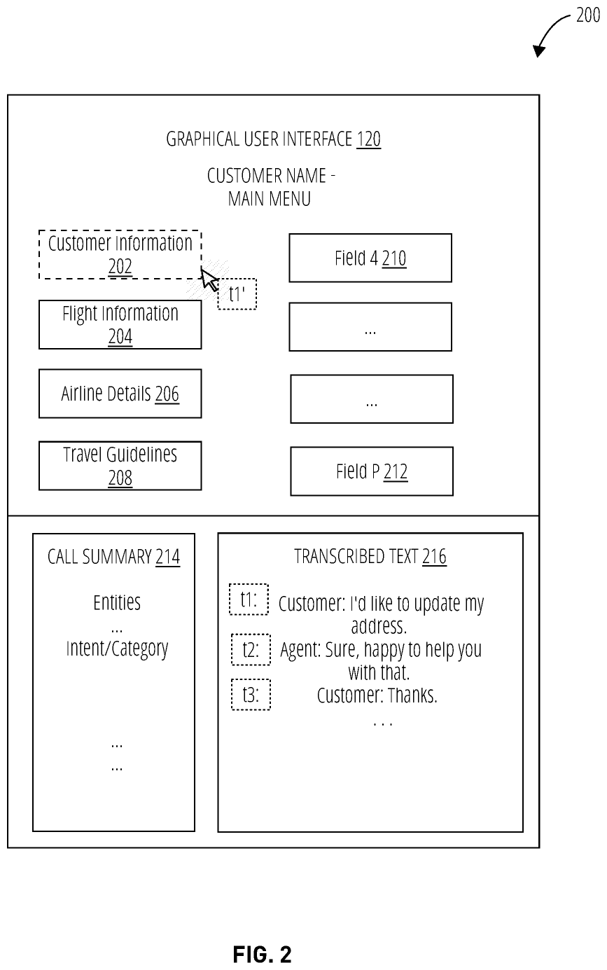

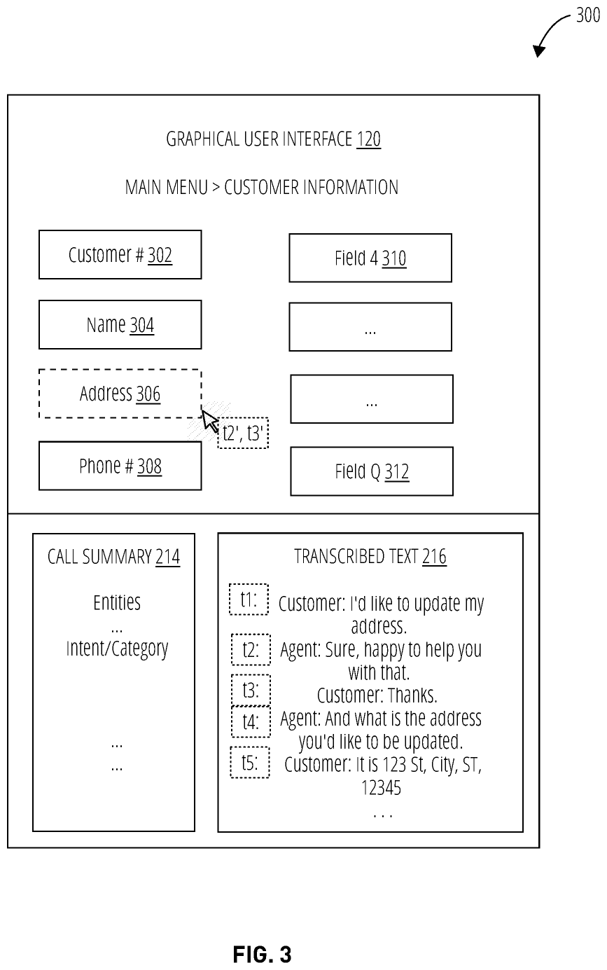

For example, FIG. 2 and FIG. 3 depict a first screen and a second screen displayed on the graphical user interface 120 (GUI 120) used by the agent 108 during a call with the customer 106. During the call, while in conversation with the agent 108, the customer 106 indicates that they would like to change their address at time instance t1, for example, by speaking “I'd like to update my address.” At this time, the agent 108 is on the main menu at the GUI 120 as shown in FIG. 2, and the main menu has several buttons, such as customer information 202, flight information 204, airline details 206, travel guidelines 208, field 4 210, . . . field p 212. Further, the GUI 120 shows the call summary 214 section, which may be automatically generated, typed in by the agent 108, or a combination thereof, and the transcribed text 216 section, showing the transcribed text of the conversation, generated using ASR techniques.

At time instance t1′, sometime after t1, the agent 108 clicks on the “customer information 202” button to get to the customer information menu in the GUI 120, as shown in FIG. 3. The customer information menu includes different fields, such as customer #302, name 304, address 306, Phone #308, field 4 310, . . . Field q 312. At time instance t2′, sometime after t1′, while the agent 108 is on the customer information menu, the agent 108 clicks on the address 306 field. The conversation in between the customer 106 and the agent 108 progresses, for example, as seen from the transcribed text representing speech at instances t1-t5, and beyond. The customer 106 provides the address to be updated at t5. At time t3′, sometime after t2′ and t5, the agent 108 types the address in the address 306 field, updating the address. The actions of the agent 108 on the GUI 120, and the time at which the actions occur are recorded, for example, by the recorder 150 as the agent activity data, and the actions of the agent 144 on the agent device 148 or the GUI 146 are recorded by the recorder 152. According to some embodiments, the recorder 150 determines a label or name of the data element or the field, for example, the identification of the field customer address, as the entity type associated with the data element. In the example of the customer address, data element has “customer address” as the identification thereof, which is extracted as the entity type associated with the data element by the recorder 150 (or recorder 152). In some embodiments, the entity type associated with the data element is determined using other methods as known in the art, such as automatically by analyzing the conversation during the agent activity associated with the data element, or as typed in by the agent in the call summary, and the like. Further, the recorder 150 determines metadata or the data type associated with the data element or the entity type, such as whether the entity type is a currency, a date, a number, and the like. In some embodiments, the recorder 150 further determines as metadata specific types number, date or currency, for example, deductible, premium, incident date, coverage start date, a customer number, a claim number, and the like.

In some embodiments, during the call or sometime after, the agent 108 may update the call summary 214 to assign an intent to the call, for example, as “change of address.” In some embodiments, intent for the call is automatically populated based on the agent's screen activity (for example, clicking on address 306 field). At the conclusion of the call or a short time thereafter, the call summary 214 including the intent of the call, and the transcribed text 216 capturing the conversation are recorded. Eventually, the call data including the intent (from the call summary 214), the transcribed text 216 and the agent activity data are sent for storage in the repository 104, for later/offline availability for the analytics server 116.

The IDGM 134 is configured to generate training data automatically from each cluster of calls. The IDGM 134 first identifies, using the agent activity data of calls within a cluster, multiple calls having a similar sequence of agent activity, that is, the calls in which a first action is followed by a second action. In some embodiments, each of the first action and the second action include one or more of typing, clicking, highlighting or reading, among other possible interactions as known in the art. In some embodiments, agent activity data and transcribed text corresponding to conversation portions identified as not relevant to the intent, for example, security questions, greetings, chit-chat, among others, are ignored from consideration of determining the sequence of agent activity. In some embodiments, the first and the second actions may or may not be consecutive, that is, there may be an intervening action between the first and the second actions. In some embodiments, the second action must be performed within a threshold number of actions (for example, 10 actions) of the first action, in order to qualify as a same sequence.

The IDGM 134 then identifies from the transcribed text of each of calls having the same sequence, a portion of the transcribed text of the calls associated with the (same) sequence. In some embodiments, the portion of the transcribed text overlapping with the duration of the sequence, that is, between the first action and the second action, is considered as being associated with the sequence. In some embodiments, the portion of the transcribed text corresponding to conversation starting a predefined period of time earlier (for example, about 5 seconds) than the first action, or starting a predefined number of turns earlier (for example, 1 or 2 turns) of the speaker(s) (agent or customer) before the first action, is also considered to be associated with the sequence. In some embodiments, the portion of the transcribed text corresponding to conversation ending after a predefined period of time after (for example, about 2 seconds) the second action, or ending a predefined number of turns after (for example, 1 or 2 turns) of the speaker(s) (agent or customer) after the second action, is also considered to be associated with the sequence. It is theorized that the conversation between such sequence of actions, and just before and/or after such sequence is relevant to the intent of the call. Such portions of the conversation, that is, the transcribed text from different calls within the cluster are identified by the IDGM 134 as being relevant to the intent of the cluster. Such portions of the transcribed text are combined automatically by the IDGM 134, and are referred to as automatically generated training data 136 or AGTD 136. The AGTDs (for example, AGTDs 136, 154) are highly accurate data pertinent to the intent of the cluster, and are usable for training AI/ML models for predicting intent based on conversations, for example, based on an input of transcribed text of calls.

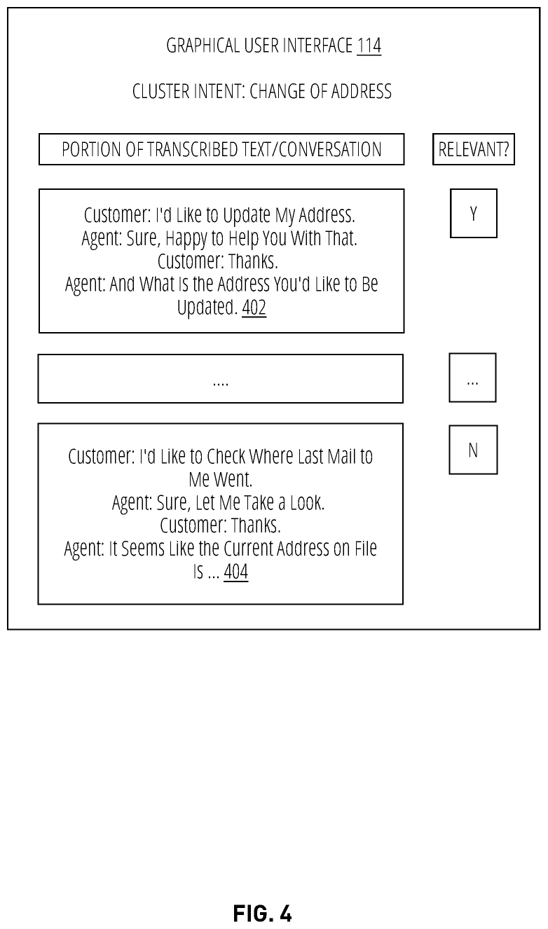

In some embodiments, the IDGM 134 is configured to further validate the AGTD 136 generated by a secondary input, such as a human input. For example, each of the portions of the transcribed text of the AGTD 136 is sent by the IDGM 134 to the business analyst device 112, for review by a business analyst, who affirms or negates the AGTD 136 or a portion thereof as being relevant to the intent of the cluster. In some embodiments, for example, as seen in FIG. 4, the business analyst uses the GUI 114 on the business analyst device 112 to display and validate the the portions of transcribed conversation, AGTD 136 or portions thereof. The portion(s) of the transcribed text/conversation of the AGTD 136 negated by the business analyst, that are indicated as being not relevant to the intent of the cluster (for example, a NO or N indicated on portion 404), are removed from the AGTD 136, while other portions of the transcribed text that are either affirmed (for example, a Yes or Y indicated on portion 402) by the business analyst as being relevant, or are not negated by the business analyst are assumed to be relevant to the intent of the cluster and are preserved. The preserved portions of the transcribed text is assimilated as validated data VTD 138. In some embodiments, the IDGM 134 sends the various portions of the transcribed text of the AGTD 136 for being reviewed, for example, to the GUI 114 of the business analyst device 112, and receives the input from the business analyst device 112, for example, as entered by the business analyst, on whether a portion of the transcribed text of the AGTD 136 is relevant to the intent or not. The IDGM 134 removes the portions of the transcribed text indicated as not being relevant by the business analyst from the AGTD 136 to generate the VTD 138. The VTDs (for example, VTDs 138, 156) are also highly accurate data pertinent to the intent of the cluster, and are usable for training AI/ML models to predict an intent of a call, based on an input of transcribed text of calls.

AGTDs and optionally VTDs are generated for each intent cluster, for example, AGTD 136 and VTD 138 for intent1 cluster 122, and AGTD 154 and VTD 156 for intentM cluster 124. Models can be trained using the AGTDs or the VTDs quicker than models that are trained on entire transcribed text of the calls, and are also more accurate.

The network 118 is a communication network, such as any of the several communication networks known in the art, and for example a packet data switching network such as the Internet, a proprietary network, a wireless GSM network, among others. The network 118 is capable of communicating data to and from various connected apparatus 100 components, for example, the call audio source 102, the repository 104, the agent device 200, the ASR Engine 110, the business analyst device 112, and the Analytics server 116. In some embodiments, one or more apparatus 100 components are communicably coupled via a direct communication link (not shown), and may or may not be communicably coupled via the network 118. For example, the agent devices 140, 148 may send the agent activity data to the repository 104 either directly via the network 118, via the infrastructure of the call audio source 102 through the network 118, or via a direct link to the repository 104.

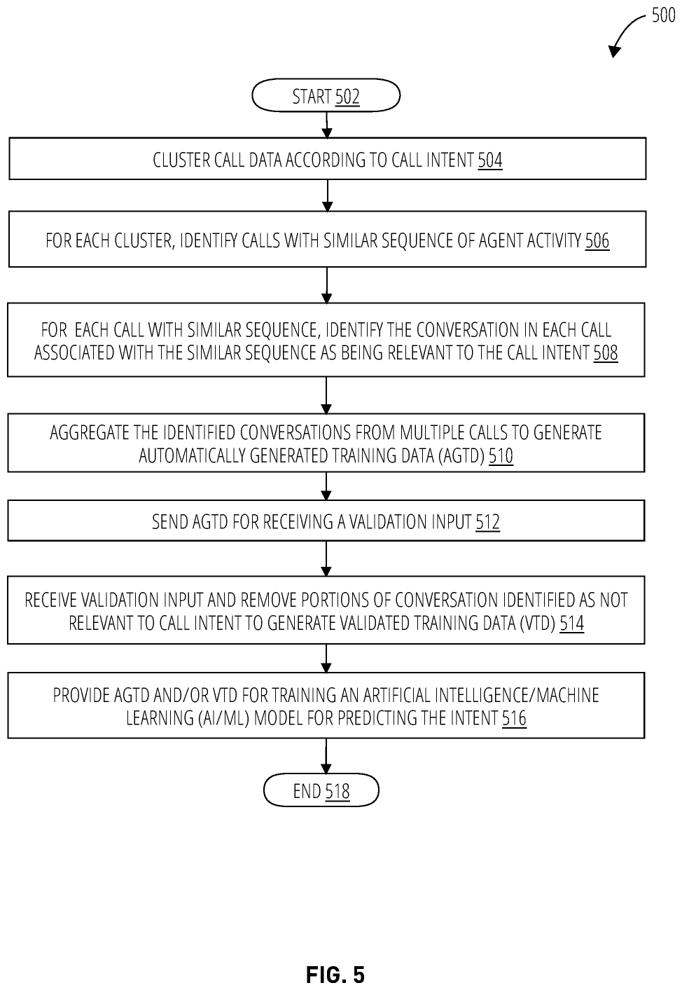

FIG. 5 illustrates a method 500 for generating data to train models for predicting intent from conversations, for example, as performed by the IDGM 134 of the apparatus 100 of FIG. 1, in accordance with an embodiment of the present invention.

The method 500 starts at step 502. Call data including the transcribed text, the agent activity data and the intent for several calls is made available at the analytics server 116 to the method 500, for example, from the repository 104, or other techniques described herein with respect to FIGS. 1-3 above, or as known in the art.

At step 504, the method 500 clusters call data according to call intent. For example, the method 500 organizes all call data having a particular intent, intent1, for example, change of address, as a single cluster, for example, intent1 cluster 122, and all call data having a particular intent, intentM as a single cluster, for example, intentM cluster 124, as shown in FIG. 1.

At step 506, the method 500 identifies from each cluster, for example, from intent1 cluster 122, calls having a similar sequence of agent activity. For example, the method 500 analyzes the agent activity data for each call in the intent1 cluster 122, and identifies call1 data 126 and callN data 128 as having a similar sequence of agent activity. As discussed above, a similar sequence of agent activity includes two or more actions performed by an agent, one after the other, in a sequence. For example, the method 500 detects that call1 agent activity data 132 includes a first sequence of a first action followed by a second action, and callN agent activity data (not shown) includes a second sequence having the same first action followed by the same second action. While there may be different or no actions performed in between the first action and the second action in call1 and callN by respective agent(s), the first and second sequences are deemed similar because the first action is followed by the second action. As also discussed above, in some embodiments, certain portions of the conversation and screen activity may be ignored for evaluating similar sequences, and in some embodiments, the sequences may be deemed similar only if the second action follows the first action within a threshold of intervening number of actions.

For illustration, in call1 held between the customer 106 and the agent 108, the first action is, for example, the action of selecting the address 306 field is performed by the agent 108 at t2′ as shown in FIG. 3, after t1 and before t4. The second action is, for example, the action of typing in the address 306 field, which is performed by the agent 108 at t3′ as shown in FIG. 3, some time after t5. Similarly, callN is held between the customer 142 and the agent 144, who may select an address field on the respective GUI 146 as a first action, followed by hovering the cursor over a call summary section in the GUI 146 as an intervening action, followed by typing in the address field on the GUI 146 as a second action.

At step 508, for calls within a cluster and containing a similar sequence of screen activity, for example, call1 and callN as identified at step 506, the method 500 identifies the conversation in each of the calls overlapping with the similar sequence as being relevant to the call intent. For example, the method 500 identifies conversation between the first action at t2′ and the second action at t3′ as a first sequence, relevant to the call intent of “change of address.” Similarly, the method 500 identifies the conversation of callN between the corresponding first and second actions as a second sequence, similar to the first sequence, and relevant to the call intent of “change of address.” In some embodiments, the method 500 includes, in the conversation identified as relevant to the intent, additional conversation from before the first action or after the second action in the identified conversation, for example, by a predefined duration of time (for example, 2 s or 5 s), or a predefined number of turns (for example, 2 or 3 turns) of the conversation.

At step 510, the method 500 aggregates or combines the identified conversations at step 508 from multiple calls, for example, from call1 and callN, to generate training data, referred to as automatically generated training data (AGTD).

In some embodiments, at step 512, the method 500 sends the AGTD for receiving a validation input on the AGTD. For example, the AGTD is sent to the business analyst device 112, for display on the GUI 114, as discussed with respect to FIG. 4, for receiving a validation input from a business analyst on AGTD or portions thereof.

At step 514, the method 500 receives a validation input, for example, from the business analyst device 112, as provided by the business analyst via the GUI 114 thereon. The portions of AGTD may be identified as being relevant, not relevant, or no response may be received on some portions. Still at step 514, the method 500 removes at least those portions of conversation from the AGTD that are identified as not relevant to the call intent, to generate validated training data (VTD). The AGTD contains conversations relevant to the intent, with a high degree of accuracy, and the VTD contains conversations relevant to the intent with at least as much accuracy as the AGTD or higher.

At step 516, the method 500 provides the AGTD or the VTD for training an artificial intelligence/machine learning (AI/ML) model for predicting the intent. For example, the method 500 may send the AGTD or the VTD to a computing device on which the model for predicting intent based on conversations is implemented, or publish the AGTD of the VTD at a location from where the AGTD or the VTD may be accessed by parties wanting to train a model for predicting intent based on conversations.

The method 500 proceeds to step 518, at which the method 500 ends.

In this manner, the embodiments disclosed herein enable generating high quality training data for training models for predicting intent from conversations, without requiring a data science expert to validate the training data. The models can thus be trained faster, are more accurate and/or have higher computational efficiency. Such models can be used to detect intent while the calls are active or live, in real time or as soon as possible within the physical constraints of the apparatus, with introduced delays, or offline.

While various techniques discussed herein refer to conversations in a call center environment, the techniques described herein are not limited to call center applications. Instead, application of such techniques is contemplated to any audio and/or text that may utilize the disclosed techniques, including single party (monologue) or a multi-party speech. While some specific embodiments have been described, combinations thereof, unless explicitly excluded, are contemplated herein.

In the above discussion, it is understood that in some case, the same agent may converse with different customers over different calls for the same call intent, and with the same customer over different calls with the same call intent, and similarly, the same customer may converse with different agents over different calls with the same call intent, and each of such different calls may be aggregated in the same intent cluster. Further, for different intents, same entity type may be used, and each entity is referred to as a slot. The techniques used above are usable to train models to distinguish the slots.

Various computing devices described herein, such as computers, for example, the agent devices 140, 148, the business analyst device 112, the analytics server 116, among others, include a CPU communicatively coupled to support circuits and a memory. The CPU may be any commercially available processor, microprocessor, microcontroller, and the like. The support circuits comprise well-known circuits that provide functionality to the CPU, such as, a user interface, clock circuits, network communications, cache, power supplies, I/O circuits, and the like. The memory is any form of storage used for storing data and computer readable instructions, which are executable by the CPU. Such memory includes, but is not limited to, random access memory, read only memory, disk storage, optical storage, various non-transitory storages known in the art, and the like. The memory includes computer readable instructions corresponding to an operating system, other computer readable instructions capable of performing described functions, and data needed as input for the computer readable instructions, or generated as output by the computer readable instructions.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

I/We claim:

1. A computer implemented method for generating training data to train models for predicting intent from conversations, the method comprising:
identifying, from a cluster of a plurality of calls having an intent, a first call data and a second call data,
the first call data comprising
a first sequence comprising a first action followed by a second action performed by a first agent on a first graphical user interface while speaking to a first customer in the first call, and
a first transcribed text corresponding to the conversation between the first agent and the first customer, and
the second call data comprising
a second sequence comprising the first action followed by the second action performed by a second agent on a second graphical user interface while speaking to a second customer in the second call,
a second transcribed text corresponding to the conversation between the second agent and the second customer;
identifying, from the first call data, at least one first portion of the first transcribed text overlapping with the first sequence;
identifying, from the second call data, at least one second portion of the second transcribed text overlapping with the second sequence; and
combining the at least one first portion, the at least one second portion and the intent to generate an automatically generated training data (AGTD) for the intent.

2. The computer implemented method of claim 1, wherein the at least one first portion further includes transcribed text corresponding to conversation beginning before the first action, after the second action, or both.

3. The computer implemented method of claim 2, wherein the conversation beginning before the first action comprises the conversation beginning a predefined duration before the first action.

4. The computer implemented method of claim 3, wherein the predefined duration is about 5 seconds.

5. The computer implemented method of claim 2, wherein the conversation beginning before the first action comprises the conversation beginning a predefined number of turns before the first action, after the second action, or both.

6. The computer implemented method of claim 5, wherein the predefined number of turns is 2.

7. The computer implemented method of claim 1, further comprising training a model for predicting the intent using the AGTD.

8. The computer implemented method of claim 1, further comprising:
sending the at least one first portion to a business analyst device for a validation input indicating either that an evaluated portion of the at least one first portion is relevant to the intent, or not relevant to the intent;
receiving the validation input from the business analyst device; and
generating validated training data (VTD) by removing the evaluated portion from the AGTD if the evaluated portion is indicated as not relevant, or preserving the evaluated portion in the AGTD if the evaluated portion is indicated as relevant.

9. The computer implemented method of claim 8, further comprising training a model for predicting the intent using the VTD.

10. The computer implemented method of claim 1, wherein at least one of the first agent, the first customer, the first graphical user interface or the first sequence is the same as the second agent, the second customer, the second graphical user interface or the second sequence, respectively.

11. A computing apparatus comprising:
a processor; and
a memory storing instructions that, when executed by the processor, configure the apparatus to:
identify, from a cluster of a plurality of calls having an intent, a first call data and a second call data,
the first call data comprising
a first sequence comprising a first action followed by a second action performed by a first agent on a first graphical user interface while speak to a first customer in the first call, and
a first transcribed text corresponding to the conversation between the first agent and the first customer, and
the second call data comprising
a second sequence comprising the first action followed by the second action performed by a second agent on a second graphical user interface while speak to a second customer in the second call,
a second transcribed text corresponding to the conversation between the second agent and the second customer;
identify, from the first call data, at least one first portion of the first transcribed text overlapping with the first sequence;
identify, from the second call, at least one second portion of the second transcribed text overlapping with the second sequence; and
combine the at least one first portion, the at least one second portion and the intent to generate an automatically generated training data (AGTD) for the intent.

12. The computing apparatus of claim 11, wherein the at least one first portion further includes transcribed text corresponding to conversation beginning at least a predefined duration or a predefined number of turns before the first action.

13. The computing apparatus of claim 12, wherein the predefined duration is about 5 seconds, or the predefined number of turns is 2.

14. The computing apparatus of claim 11, wherein the instructions further configure the apparatus to:
send the at least one first portion to a business analyst device for a validation input indicating either that an evaluated portion of the at least one first portion is relevant to the intent, or not relevant to the intent;
receive the validation input from the business analyst device; and
generate validated training data (VTD) by removing the evaluated portion from the AGTD if the evaluated portion is indicated as not relevant, or preserving the evaluated portion in the AGTD if the evaluated portion is indicated as relevant.

15. The computing apparatus of claim 14, wherein the instructions further configure the apparatus to send the AGTD or the VTD for training a model for predicting the intent.

16. A non-transitory computer-readable storage medium, the computer-readable storage medium including instructions that when executed by a computer, cause the computer to:
identify, from a cluster of a plurality of calls having an intent, a first call data and a second call data,
the first call data comprising
a first sequence comprising a first action followed by a second action performed by a first agent on a first graphical user interface while speak to a first customer in the first call, and
a first transcribed text corresponding to the conversation between the first agent and the first customer, and
the second call data comprising
a second sequence comprising the first action followed by the second action performed by a second agent on a second graphical user interface while speak to a second customer in the second call,
a second transcribed text corresponding to the conversation between the second agent and the second customer;
identify, from the first call data, at least one first portion of the first transcribed text overlapping with the first sequence;
identify, from the second call, at least one second portion of the second transcribed text overlapping with the second sequence; and
combine the at least one first portion, the at least one second portion and the intent to generate an automatically generated training data (AGTD) for the intent.

17. The computer-readable storage medium of claim 16, wherein the at least one first portion further includes transcribed text corresponding to conversation beginning at least a predefined duration or a predefined number of turns before the first action.

18. The computer-readable storage medium of claim 17, wherein the predefined duration is about 5 seconds, or the predefined number of turns is 2.

19. The computer-readable storage medium of claim 16, wherein the instructions further configure the computer to:
send the at least one first portion to a business analyst device for a validation input indicating either that an evaluated portion of the at least one first portion is relevant to the intent, or not relevant to the intent;
receive the validation input from the business analyst device; and
generate validated training data (VTD) by removing the evaluated portion from the AGTD if the evaluated portion is indicated as not relevant, or preserving the evaluated portion in the AGTD if the evaluated portion is indicated as relevant.

20. The computer-readable storage medium of claim 19, wherein the instructions further configure the computer to send the AGTD or the VTD to train a model for predicting the intent.
